(19) United States
(12) Patent Application Publication
(10) Pub. No.: US 2016/0002467 A1
(43) Pub. Date: Jan. 7, 2016

(54) THERMOPLASTIC POLYMER COMPOUNDS WITH LOW-MOLECULAR LIGNINS, METHOD FOR THE PRODUCTION THEREOF, MOULDED ARTICLES AND ALSO USES

(71) Applicant: FRAUNHOFER-GESELLSCHAFT ZUR FÖRDERUNG DER ANGEWANDTEN FORSCHUNG E.V., München (DE)

(72) Inventors: Jens ERDMANN, Berlin (DE); Johannes GANSTER, Potsdam (DE); Gunnar ENGELMANN, Potsdam (DE)

(73) Assignee: FRAUNHOFER-GESELLSCHAFT ZUR FÖRDERUNG DER ANGEWANDTEN FORSCHUNG E.V., München (DE)

(21) Appl. No.: 14/767,053

(22) PCT Filed: Feb. 3, 2014
(86) PCT No.: PCT/EP2014/052022

§ 371 Date: Aug. 11, 2015

(30) Foreign Application Priority Data
Feb. 11, 2013 (DE) 10 2013 002 573.7

(51) Int. Cl. C08L 97/00; C08L 77/06

(52) U.S. Cl. CPC C08L 97/005; C08L 77/06

(57) ABSTRACT

Thermoplastic polymer compound comprising a thermoplastic matrix polymer or a blend of at least two thermoplastic matrix polymers and also at least one low-molecular lignin and/or low-molecular lignin derivative having a weight-averaged molecular weight of 200 to 6,000 g/mol.

Thermoplastically processable polymer mixtures consisting of special low-molecular lignin fractions and a thermoplastic matrix are described. The polymer mixtures have, in the case of high lignin contents (50%) relative to the elastic matrix, equal or higher strength, rigidity and breaking elongation. In order to improve the homogeneous miscibility with the matrix, the low-molecular lignin fractions can in addition be chemically modified. The lignin derivatives can be completely or partially substituted. The substituents belong to the group of aliphatic, olefinic and aromatic compounds and can be used in combination. This concerns CH compounds which comprise heteroatoms, such as for example oxygen, nitrogen, sulphur or phosphorus. The matrix polymers belong to the group of linear heterochain polymers which can also comprise side groups or side chains. The side groups or side chains are likewise characterised by aliphatic, olefinic and aromatic structural elements, and also combinations thereof. They comprise polar heteroatoms and can be the same as or different from the substituents of the lignin derivatives.

The use of lignin for the production of thermoplastic materials is the subject of numerous publications, two factors playing an essential role for the production process itself and also for the material properties. For the large part, the lignin properties are determined by the origin of the lignin (plant type, location), the pulping process and also the isolation from the black lye. It is thereby shown that lignins which originate from the kraft process or various organosolv processes are very suitable for thermoplastic processing. This applies both for thermoplastics with lignin as filler or as matrix (DE 19852067 A1).

By the addition of lignin to typical, linear-chain polymers, the result is, with an increasing lignin content, significant improvement in the material rigidity, the strength however generally decreasing again after a specific lignin content. Lignin itself can likewise have very high rigidities after completion of thermoplastic processing, however the strength of such materials is only present in a limited fashion. In order to improve this, reinforcement with various fibres is considered, natural fibres in combination with lignin playing an essential role (DE 19852081 C1).

In addition, as a function of their chemical structure, the physical properties and the degree of admixing, plasticisers offer the possibility of endowing lignins with thermoplasticity. The use of fairly large quantities of plasticiser means however trade-offs in the mechanical characteristics, such as strength and rigidity. These plasticisers can be of a molecular nature, such as for example water or glycerine, but also polymers (PEG).

Many examples of lignin-comprising thermoplastic materials can be found in the literature. Classification can be undertaken both according to the type of lignins which are used and according to the selected matrix polymers. In the case of the matrix polymers, a differentiation can be made between synthetic and biopolymers. In this context, there belong to the group of bio-based polymers, above all PLA, hydroxypropyl cellulose, hemicellulose, cellulose esters (cellulose acetate, cellulose acetate butyrate, cellulose propionate), proteins and also starch. In the production of the material mixtures, in addition to the thermoplastic processing, also mixing of the polymers with the assistance of solvents is described. Representatives of the synthetic matrix polymers are for example: PVC, polyvinylacetate, vinylcopolymers, PE, PP, PU, poly(8-caprolactone), PEG, poly[4-vinylpyridine], PMMA, polyester, polyvinyl alcohol, polyaniline and other polymers.

For the use of lignin as component of thermoplastic polymers, in addition to the use as filler, also useful properties with respect to processing aids are explained. Thus the flow behaviour of various polyesters, such as PC, PET, PBT and PPT, can be improved by the use of small quantities of various lignins (0.1-5%). The presence of lignin in PE- and PP-based polymer films ensures an improvement in the degradation behaviour, lignin powder with defined particle sizes (1-5 μm) being accepted as particularly effective.

In addition to the use of non-modified lignins as material components, also lignin derivatives are the subject of intensive research in order to be able to influence or even control, by means of this step, atypical properties, such as for example the solubility in apolar media, the variation in the glass transition temperatures, the reactivity relative to various reagents or the compatibility with various polymers as blend component. With respect to polymer mixtures, a differentiation should be made with respect to the lignin derivatives (A) and the matrix components (B):

### (A)

In general, reactions, such as acylation, alkylation, urethane formation, halogenation, nitration, sulphonation, oxidation, reduction or simple hydrolysis are used for the chemical modification, the focus being on the first three mentioned methods from the point of view of thermoplastic applications.

The simplest variant of derivatisation is the complete conversion of lignin with a monovalent reagent so that uniform substituent patterns dominate in these polymers. In the scientific and patent literature, a large number of examples have been published in this respect which concentrate essentially on esters and ethers, the focus on esters being evident.

The first investigations into esterification of lignin dealt with aliphatic monocarboxylic acids of different alkyl chain lengths in order to be able to study in particular the influence on the thermoplastic behaviour. Monocarboxylic acids with up to 18 C atoms in the alkyl chains were thereby used. Reduction in the glass transition temperature with increasing alkyl chain length in these lignin esters could be detected thus, which was also confirmed by other works. Recently, the focus within the scope of such studies has been rather on carboxylic acids with 2-12 C atoms.

Extending the spectrum of lignin derivatives can be undertaken by equipping such naturally renewable polymers with reactive groups which allow subsequent reactions. A differentiation is thereby made between lignin-typical functions, such as OH groups in the form of hydroxyalkyl ethers, or lignin-atypical reactive groups, such as for example epoxides, acrylates or methacrylates, etc. Such compounds then serve as intermediate or pre-polymers for the production of other polymers, for example polyurethanes.

In addition to these groups, lignin derivatives, which are synthesised with a plurality of monovalent reagents and can be described as polymers with non-uniform substituent patterns, are also described. Glasser et al. reported on lignin derivatives with aliphatic polyalkyl ether chains as second substituent. Firstly, monovalent reagents can hereby be used for blocking OH groups of the lignin, such as for example alkylation means from the group of alkyl halides or dialkyl sulphates. As a result, a previously determined number of OH groups can be deactivated. The remaining OH functions can then be used with suitable reagents in the sense of chain-lengthening reactions, in order to bond oligomer- or polymer chains to the lignins. Glasser et al. start, in this context, from a star-shaped polymer architecture. Such lignin derivatives can also be assigned, in the view of the authors, according to the structure of the chain-shaped segments, also to the group of thermoplastic elastomers. The oligomer or polymer chains bonded to lignin concern aliphatic polyethers or polyesters which are constructed respectively by ring-opening reactions from cyclic monomers. Because of the remaining terminal OH groups, such special lignin derivatives are suitable as macromonomers for the preparation of resin formulations or directly for the synthesis of polymers, such as for example polyurethanes, a second monomer component being required for this purpose.

### (B)

Lignin derivatives as component or matrix of thermoplastically processable polymer mixtures are described comparatively little in the literature. Hydroxypropyl lignins (HPL) in combination with PMMA, polyvinyl alcohol, cellulose triacetate, graft copolymers or styrene are described. Therefore reactive OCN end groups of special styrenes allow reactions with HPL, polymers of a star-shaped architecture being produced. This structure feature applies also for lignin in combination with caprolactone. Aliphatic lignin esters, such as acetate, butyrate, hexanoate and laurate in combination with cellulose acetate butyrate and PHB with lignin butyrate, were investigated. Essential aspects in these studies are the exploration of the compatibility between these polymers and also the effects on the softening behaviour of the blends or the processability thereof.

The use of lignin as filler for thermoplastic composites effects, in most cases, an increase in rigidity and also causes an increase in material strength. An essential consequence is however, in particular with polymers with comparatively high breaking elongation, the loss of elasticity, which is indicated for example by a drastic reduction in the 8 values. One possibility for countering this effect is the use of plasticisers, which however in turn involves negative consequences for the strength and rigidity of the composites.

Starting herefrom, it is hence the object of the present invention to indicate thermoplastic composite materials or polymer compounds which are lignin-filled, but nevertheless have high elasticity. In addition, it is the object of the present invention to produce corresponding polymer compounds or to indicate moulded articles and purposes of use hereof.

This object is achieved, with respect to a thermoplastic polymer compound, by the features of patent claim 1, with respect to a production method, by the features of patent claim 17, with respect to a moulded article, by the features of patent claim 21 and also with respect to purposes of use of a polymer compound or of a moulded article according to the invention, by the features of patent claim 22. The respective dependent patent claims thereby represent advantageous developments.

The invention hence relates to a thermoplastic polymer compound comprising a thermoplastic matrix polymer or a blend of at least two thermoplastic matrix polymers and also at least one low-molecular lignin and/or low-molecular lignin derivative having a weight-averaged molecular weight of 200 to 6,000 g/mol.

The above-mentioned problems are hence solved according to the invention in that a low-molecular lignin fraction of a lignin and/or of a lignin derivative, which is partially or completely soluble in the polymer matrix, is incorporated in the matrix polymer. The low-molecular lignin fractions can also be modified chemically to form lignin derivatives in order to assist the homogeneous miscibility with the matrix polymer. Consequently, the matrix remains elastic, also strength and modulus being able to be maintained and increased relative to the pure matrix polymer.

In order to obtain the low-molecular lignin fraction, kraft lignins and sulphur-free lignins from various organosolv processes are suitable. Lignins from annual plants which occur for example in the production of bioethanol are characterised by comparatively low solubility in various solvents. This resides primarily in a high molecular weight and also a more complex branching- or crosslinking pattern of the lignin components. By means of a subsequent treatment with corresponding pulping processes (kraft, organosolv enzymatically, etc.), partial lignin degradation is possible, which leads to lignin substrates with lower molecular weights and therefore to improved solubility. These lignins can then be used as substrates for obtaining low-molecular lignin fractions. Lignins which originate from the various pulping processes have, because of the concrete pulping conditions, ultimately average molecular weights which move within specific limits; for kraft lignins, a molecular weight range of approx. 4,000-6,000 g/mol can be assumed. Relative to other bio-based polymers and in particular relative to linear-chain, synthetic polymers, lignins are generally characterised by a wide molar mass distribution (high polydispersity). This means that, with respect to the average molecular weight, also substantially smaller lignin molecules are present. These are distinguished by good solubilities in various solvents and ultimately also by low glass transition temperatures.

Isolation of the low-molecular fraction from a lignin substrate can be effected in principle by the most varied of organic solvents, such as for example ketones (acetone, MEK, etc.), alcohols (methanol, ethanol, etc.), esters (ethylacetate, methylpropionate, etc.), halogenated hydrocarbons (chloroform, methylene chloride, etc.), acids (acetic acid, propionic acid etc.), ethers (diethylether, THF, etc.) etc. and mixtures of the various organic solvents. A second group comprises aqueous solvent systems. This means water itself and also a mixture of water with water-soluble organic solvents. In the case of aqueous systems, the pH value can also be varied comparatively easily, pH values between 7-14 substantially improving the solubility of the lignins in the liquid phase. The transition to form low-molecular lignin fractions essentially involves an increase in the hydroxyl group number and also a reduction in the glass transition temperature. By means of lower Tg values, easier thermoplastic plastic processing of the lignins is possible. More free OH groups cause an increase in the lignin polarity but also in the chemical reactivity thereof. As a result, better interaction, in particular with polar polymers, can be expected.

There are understood by lignin derivatives, chemically modified lignins in which in particular the hydroxy functionalities of the lignin have been modified in a chemical reaction. Corresponding lignin derivatives which are used according to the invention for the thermoplastic polymer compound have an above-indicated molecular weight.

Preferred weight-averaged molecular weights of the low-molecular lignin or of the low-molecular lignin derivative are thereby from 200 to 5,000 g/mol, preferably from 200 to 4,000 g/mol, particularly preferred from 200 to 3,000 g/mol.

The low-molecular lignin or lignin derivative is present preferably completely dissolved in the thermoplastic matrix polymer, i.e. no particles of the lignin or of the low-molecular lignin are detectable any longer. Hence complete homogenisation of the polymer compound is ensured.

In the case where the lignin or derivative hereof is present partially dissolved in the thermoplastic matrix, the undissolved part of the low-molecular lignin and/or of the low-molecular lignin derivative is present in particulate form, the average particle sizes of these particles being 100 nm, preferably 20 nm, further preferred 20 nm, particularly preferred 10 nm. The average particle sizes can be determined by means of measuring methods known in the literature. In particular, DSC- or DMA methods are possible (Kaplan, D. S., Structure-property relationships in copolymers to composites: Molecular interpretations of the glass transition phenomenon, J. Appl. Polym. Sci. 1976, 20 (10), 2615-2629; Utracki, L. A., Polymer Alloys and Blends; Hanser Gardner Publications: Munich, 1990; [3] Nishio, Y., Hyperfine composites of cellulose with synthetic polymers in Cellulose Polymers, Blends, and Composites; Gilbert, R. D., Ed.; Hanser: Munich, N. Y., 1994; 95-113) or Solid Body NMR Spectroscopy (Masson, J. F.; Manley, R. S., Cellulose poly(4-vinylpyridine) blends, Macromolecules 1991, 24 (22), 5914-5921; Grobelny, J.; Rice, D. M.; Karasz, F. E.; MacKnight, W. J., High-resolution solid-state C-13 nuclear magnetic resonance study of polybenzimidazole/polyimide blends, Macromolecules 1990, 23 (8), 2139-2144; Zhang, X. Q.; Takegoshi, K.; Hikichi, K., High-resolution solid-state C-nuclear magnetic resonance study on poly(vinyl alcohol)/poly(vinylpyrrolidone) blends, Polymer 1992, 33 (4), 712-717) as specific methods for determining the average particle sizes.

According to a further preferred embodiment, also a further lignin or lignin derivative with a weight-averaged molecular weight of >6,000 g/mol, preferably 6,100 g/mol to 20,000 g/mol are contained.

As lignin source, both for the low-molecular lignin fraction and for the further higher-molecular lignin, both hardwood- and softwood lignins are used, e.g. made of deciduous or coniferous sources, which originate for example from the kraft process or sulphur-free lignins from corresponding organosolv processes. Lignins from annual plants which occur for example after bioethanol production as residual materials can also be used as substrate after application of a lignin-degrading process (kraft, organosolv, enzymatically).

The low-molecular lignin fraction can be obtained from corresponding lignin sources by means of extractive processes. For the extraction, aqueous and organic solvents, such as for example acetone, MEK dioxane, methanol, ethanol, chloroform etc. and also mixtures of water and water-soluble organic solvents, are possible. When using aqueous solvents, the pH value can be between 2 and 14, preferably between 6 and 14 and very preferred between 7 and 13. The extraction is effected preferably within a temperature range between 0 and 150° C., preferably between 10 and 100° C., very preferred between 20 and 60° C.

In the case of the previously described extraction process, the low-molecular lignins go into solution. Hence, low-molecular and also higher-molecular lignins can be separated separately from a lignin substrate.

The chemical modification of lignins to form lignin derivatives—should these be included—is effected preferably after separation of the low-molecular lignin fraction.

In the case where both low and higher-molecular lignins or derivatives hereof are contained in the thermoplastic polymer compound, it is advantageous if the weight ratio of the totality of the at least one low-molecular lignin and/or low-molecular lignin derivative to the totality of the at least one further lignin and/or lignin derivative, is from 1:99 to 99:1, preferably from 20:80 to 80:20, particularly preferred from 30:70 to 70:30.

A preferred total lignin content, i.e. the sum of low-molecular lignins or derivatives hereof and possibly any further lignins present, i.e. higher-molecular lignins or derivatives hereof, is, relative to the polymer compound, from 0.1 to 80% by weight, preferably from 1 to 70% by weight, further preferred from 5 to 60% by weight, particularly preferred from 10 to 50% by weight.

Furthermore, it is advantageous if the glass transition temperature of the at least one low-molecular lignin and/or low-molecular lignin derivative is less than the glass transition temperature or the melting point of the at least one thermoplastic matrix polymer and/or the glass transition temperature of the at least one further lignin and/or lignin derivative. Glass transition temperatures of low-molecular lignins or derivatives hereof, given by way of example, are thereby in a range of <150° C., preferably <120° C., in particular <100° C.

In addition, it can be provided that the at least one low-molecular lignin derivative was obtained by partial or complete derivatisation, selected from the group of esterifications, etherifications, urethane formations or combinations of the previously mentioned derivatisations on the hydroxyl groups of a corresponding lignin.

With the derivatisation, in particular an improvement in the homogeneous miscibility between low-molecular lignin and the matrix can be achieved. The substitution degree can thereby be varied between 0 and 100%, relative to the hydroxyl number. In addition to changes in polarity, also a reduction in the glass transition temperature can be achieved, which is important for the thermoplastic processability. Lignins can be esterified, in the simplest case, by conversions with acid anhydrides or acid halides. The etherification is achieved for example by reactions with reagents based on halides, epoxides and glycidyl compounds. Urethanes are formed by the addition of isocyanates to the OH groups of the lignins.

Preferred derivatisation degrees of lignin derivatives are between 0.1 and 100%, preferably from 0.5 to 100%, relative to the number of OH groups.

Substituents of the derivatives selected from the group of aliphatic, olefinic and/or aromatic compounds are further advantageous, which compounds can comprise heteroatoms, in particular oxygen, nitrogen, sulphur and/or phosphorus.

The previously made assumptions and statements with respect to the chemical type and the quantity of derivatisation of the low-molecular lignins apply without restriction also for the further, higher-molecular lignin derivatives.

Preferred thermoplastic matrix polymers are thereby selected from the group consisting of polyamides, in particular AB polyamides (6, 11, 12) and AABB polyamides, consisting of dicarboxylic acids with 4, 6, 8, 9, 10, 12, 14, 16, 18 C atoms and diamines with 4, 6, 8, 9, 10, 12, 14, 16, 18 C atoms; polyesters, in particular PET or PLA; polyethers; cellulose or cellulose derivatives; PVC, PVA, vinyl copolymers, polyolefins, in particular PE or PP; polyurethanes; polycarbonates; polyalkylene glycols, in particular PEG; polyvinylpyridine; poly(meth)acrylates, in particular PMMA; polyvinyl alcohols; polyanilines and also combinations or blends of the previously mentioned polymers.

In addition, it is advantageous if in addition at least one adhesive is contained, preferably in a quantity of 0.01 to 10% by weight, further preferred of 0.1 to 5% by weight, further preferred of 0.5 to 3% by weight, in particular of 1 to 2% by weight.

The at least one adhesive is thereby selected advantageously from the group consisting of diisocyanates; polymers or copolymers grafted with maleic anhydride, in particular polyethylene, polypropylene, polystyrene, polyisobutene, polyethylene co-vinyl acetate or polyethylene-co-octane, grafted with maleic anhydride, and also mixtures or combinations hereof, preferably the grafting degree of the polymers or copolymers grafted with maleic anhydride being from 0.0001 to 90%, further preferred from 0.1 to 10%, particularly preferred from 3 to 8%.

The adhesive can thereby be bonded covalently, in particular via at least one ester-, ether-, amide-, amine-, urethane- or siloxane bond, and/or by semivalent bonds, in particular hydrogen bridge bonds, to the at least one low-molecular lignin and/or low-molecular lignin derivative and/or to the at least one further lignin and/or lignin derivative.

Preferably, the number-averaged molecular weight of the adhesive is from 100 to 500,000 g/mol, preferably from 500 and 50,000 g/mol, particularly preferred from 1,000 and 10,000 g/mol.

In addition, the polymer compound can comprise at least one or more further additives which are preferably selected from the group consisting of olfactory substances, substances for minimising olfactory emissions, pigments, colourants, UV- and/or light stabilisers, flame retardants, preservatives, antioxidants, natural fibres and/or synthetic fibres.

Furthermore, the invention relates to a method for the production of a polymer compound as previously described, in which a thermoplastic matrix polymer or a blend comprising or consisting of at least two thermoplastic matrix polymers is melted and there are mixed homogeneously into the melt at least one low-molecular lignin and/or low-molecular lignin derivative with a weight-averaged molecular weight of 200 to 6,000 g/mol, preferably of 200 to 5,000 g/mol, further preferred of 200 to 4,000 g/mol, particularly preferred of 200 to 3,000 g/mol.

Furthermore advantageously, a further lignin or lignin derivative can be added to the thermoplastic matrix.

The method guidance according to the invention can be effected in particular in three preferred alternatives, in which
a) either firstly complete addition of the at least one low-molecular lignin and/or of the low-molecular lignin derivative is effected and subsequently complete addition of the at least one further lignin and/or lignin derivative, or
b) firstly complete addition of the at least one further lignin and/or lignin derivative is effected and subsequently complete addition of the at least one low-molecular lignin and/or of the low-molecular lignin derivative, or
c) alternating addition of portions of the at least one low-molecular lignin and/or of the low-molecular lignin derivative and also of the at least one further lignin and/or lignin derivative
   is effected to the polymer melt of the thermoplastic matrix.

Preferred processing temperatures are thereby at most 50° C., preferably at most 30° C., particularly preferred at least 10° C. above the melting temperature of the thermoplastic matrix polymer or of the blend of at least two thermoplastic matrix polymers.

In particular, processing temperatures are at most 250° C., preferably at most 230° C., particularly preferred at most 210° C.

In addition, the present invention relates to moulded articles, produced from a polymer compound according to the invention. Preferred designs of a moulded article are thereby in particular articles in the form of a foil or a fibre.

The polymer compounds or moulded articles according to the invention are suitable in particular as constructional materials.

The present invention is explained in more detail with reference to the subsequent embodiments without restricting the invention to the specially illustrated parameters.

### EXAMPLE 1

X g of PA 11 was melted in a kneader at a temperature of 200° C. and thereafter Y g of the low-molecular lignin extract (X, Y, see table 1) was added in portions. The kneading process lasted 5 minutes at a rotational speed of 50 min⁻¹ and under an inert gas atmosphere. Subsequently, removal of the kneaded item and formation thereof to form test pieces was effected by means of injection moulding. Tables 2 and 3 contain selected results of the tension-elongation experiments (DIN EN ISO 527).

TABLE 1
Composition of the polymer mixtures

| | PA 11 [g] | lignin [g] |
|---|---|---|
| 10% | 234 | 26 |
| 20% | 208 | 52 |
| 30% | 182 | 78 |
| 40% | 156 | 104 |
| 50% | 130 | 130 |

TABLE 2
Selected results of the mechanical characterisation (DIN EN ISO
527) of PA 11/lignin mixtures of different lignin contents

| | Reference | 10% | 20% | 30% | 40% | 50% |
|---|---|---|---|---|---|---|
| σ [MPa] | 44 ± 6 | 45 ± 1 | 56 ± 1 | 54 ± 4 | 61 ± 3 | 52 ± 3 |
| E [MPa] | 1,120 ± 80 | 1,660 ± 40 | 2,020 ± 40 | 2,320 ± 30 | 2,580 ± 40 | 2,720 ± 70 |
| ε [%] | 135 ± 40 | 88 ± 10 | 52 ± 8 | 2.9 ± 0.5 | 2.9 ± 0.3 | 2.2 ± 0.2 |

TABLE 3
Selected results of the mechanical characterisation (DIN EN ISO
527) of mixtures of PA 11 and the low-molecular lignin extract

| | Reference | 10% | 20% | 40% |
|---|---|---|---|---|
| σ [MPa] | 44 ± 6 | 50 ± 1 | 53 ± 2 | 56 ± 1 |
| E [MPa] | 1,120 ± 80 | 1,660 ± 10 | 1,760 ± 60 | 2,180 ± 30 |
| ε [%] | 135 ± 40 | 149 ± 8 | 194 ± 20 | 182 ± 10 |

Surprisingly, it was shown that, when using PA11 as matrix and a low-molecular fraction of a softwood lignin up to a lignin content of 50%, the largest part of this lignin forms a homogeneous phase with PA11. As a result, it was possible partially to increase the elasticity of PA11 which can be indicated by a breaking elongation (E) of 135% (40% lignin extract, 8=182%). Also tensile strength and rigidity were able to be improved relative to pure PA11 (43.5 MPa and 1,120 MPa) to 56.2 MPa or 2,180 MPa. If the lignin substrate (40%), from which the low-molecular extract was obtained, is compared therewith, then a tensile strength at 60.9 MPa and a modulus at 2,580 MPa could be determined, however the breaking elongation was at merely 2.9%.

Surprisingly, it was also shown that, by the addition of up to 60%, preferably 50% and particularly preferred 40%, of the lignin substrate to the homogeneous polymer mixture consisting of the low-molecular lignin fraction and of the matrix, the breaking elongation could be maintained at a higher value than when using the matrix polymers without a low-molecular lignin fraction and the derivatives thereof. Due to the combination of low-molecular lignin fraction and lignin substrate, elastic composites with a higher overall content of lignin than when using the pure lignin substrate could thus be produced.

1. A thermoplastic polymer compound comprising a thermoplastic matrix polymer or a blend of at least two thermoplastic matrix polymers and at least one low-molecular lignin and/or low-molecular lignin derivative having a weight-averaged molecular weight of 200 to 6,000 g/mol.

2. The compound according to claim 1, wherein the low-molecular lignin and/or the low-molecular lignin derivative has a weight-averaged molecular weight of 200 to 5,000 g/mol.

3. The polymer compound according to claim 1, wherein the low-molecular lignin and/or the low-molecular lignin derivative in the at least one thermoplastic matrix polymer
a) is present completely dissolved, or
b) is present partially dissolved, the undissolved part of the low-molecular lignin and/or of the low-molecular lignin derivative being present in particulate form, and the average particle sizes of these particles being ≦100 nm.

4. The polymer compound according to claim 1, wherein at least one further lignin and/or lignin derivative with a weight-averaged molecular weight of >6,000 g/mol is contained.

5. The polymer compound claim 4, wherein the weight ratio of the totality of the at least one low-molecular lignin and/or low-molecular lignin derivative to the totality of the at least one further lignin and/or lignin derivative is from 1:99 to 99:1.

6. The polymer compound according to claim 1, wherein the total lignin content is, relative to the polymer compound, from 0.1 to 80% by weight.

7. The polymer compound according to claim 1, wherein the glass transition temperature of the at least one low-molecular lignin and/or low-molecular lignin derivative is less than the glass transition temperature or the melting point of the at least one thermoplastic matrix polymer and/or the glass transition temperature of the at least one further lignin and/or lignin derivative.

8. The polymer compound according to claim 1, wherein the at least one low-molecular lignin derivative was obtained by partial or complete derivatisation, selected from the group of esterifications, etherifications, urethane formations or combinations of the previously mentioned derivatisations on the hydroxyl groups of a corresponding lignin.

9. The polymer compound according to claim 1, wherein the derivatisation degree relative to the number of OH groups is between 0.1 and 100%.

10. The polymer compound according to claim 1, wherein substituents of the derivatives are selected from the group of aliphatic, olefinic and/or aromatic compounds, which optionally comprise one or more heteroatoms.

11. The polymer compound according to claim 1, wherein the thermoplastic matrix polymer is selected from the group consisting of polyamides, polyesters, PVC, PVA, vinyl copolymers, polyolefins, polyalkylene glycols, poly(meth)acrylates, polyanilines and combinations or blends of the previously mentioned polymers.

12. The polymer compound according to claim 1, wherein at least one adhesive is contained in a quantity of 0.01 to 10% by weight.

13. The polymer compound according to claim 12, wherein the at least one adhesive is selected from the group consisting of diisocyanates; polymers or copolymers grafted with maleic anhydride, in particular polyethylene, polypropylene, polystyrene, polyisobutene, polyethylene co-vinyl acetate or polyethylene-co-octane, grafted with maleic anhydride, and mixtures or combinations thereof.

14. The polymer compound according to claim 12, wherein the adhesive is bonded covalently, to the at least one low-molecular lignin and/or low-molecular lignin derivative and/or to the at least one further lignin and/or lignin derivative.

15. The polymer compound according to claim 12, wherein the number-averaged molecular weight of the adhesive is from 100 to 500,000 g/mol.

16. The polymer compound according to claim 1, wherein the low-molecular lignin, the lignin which forms the basis of the low-molecular lignin derivative, the further lignin and/or the lignin which forms the basis of the further lignin derivative originates from coniferous or deciduous sources and annual plants and/or is obtained by the kraft process, organosolv process, enzymatic processes or by extractive processes.

17. The polymer compound according to claim 1, which further includes additives.

18. A method for the production of a polymer compound according to claim 1, wherein a thermoplastic matrix polymer or a blend comprising at least two thermoplastic matrix polymers is melted and are mixed homogeneously into the melt at least one low-molecular lignin and/or low-molecular lignin derivative with a weight-averaged molecular weight of 200 to 6,000 g/mol.

19. The method according to claim 18, wherein at least one further lignin and/or lignin derivative with a weight-averaged molecular weight of >6,000 g/mol are added to the polymer melt.

20. The method according to claim 19, wherein, in the polymer melt,
a) firstly complete addition of the at least one low-molecular lignin and/or of the low-molecular lignin derivative is effected and subsequently complete addition of the at least one further lignin and/or lignin derivative, or
b) firstly complete addition of the at least one further lignin and/or lignin derivative is effected and subsequently complete addition of the at least one low-molecular lignin and/or of the low-molecular lignin derivative, or
c) alternating addition of portions of the at least one low-molecular lignin and/or of the low-molecular lignin derivative and of the at least one further lignin and/or lignin derivative is effected.

21. The method according to claim 18, wherein the processing temperature is at most 50° C. above the melting temperature of the thermoplastic matrix polymer or of the blend of at least two thermoplastic matrix polymers and/or at most 250° C.

22. A moulded article, produced from a polymer compound according to claim 1, in the form of a film or a fibre.

23. (canceled)
